(19) United States
(12) Patent Application Publication
(10) Pub. No.: US 2008/0158800 A1
(43) Pub. Date: Jul. 3, 2008

(54) ELECTRONIC APPARATUS

(75) Inventor: Tatsuya Aoyagi, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 11/836,119

(22) Filed: Aug. 8, 2007

(30) Foreign Application Priority Data
Dec. 27, 2006 (JP) P2006-352218

(51) Int. Cl. G06F 1/16

(52) U.S. Cl. 361/681

(57) ABSTRACT

According to one embodiment, an electronic apparatus having a main part and a display part which pivotally opens and closes relative to the main part, the apparatus including an electromagnet provided in one of the main part or the display part, a permanent magnet provided in the other one of the main part or the display part, and a detection device detecting pivotal movement of the display part, in which when the detection device detects pivotal movement of the display part in an opening direction, the detection device causes the electromagnet to generate a magnetic force to bounce back from the permanent magnet.

### CROSS-REFERENCE TO RELATED APPLICATIONS

This application is based upon and claims the benefit of priority from Japanese Patent Application No. 2006-352218, filed Dec. 27, 2006, the entire contents of which are incorporated herein by reference.

### BACKGROUND

1. Field

One embodiment of the invention relates to an electronic apparatus having a main part and a display part which pivotally opens and closes relative to the main part.

2. Description of the Related Art

As conventional electronic apparatuses, there are known ones to which an opening/closing assist mechanism as follows is applied (for example, refer to Japanese Patent Application Publication (KOKAI) No. H04-327034). Specifically, it is an opening/closing assist mechanism with a main part having an electromagnet and a display part having a closed loop coil, in which when the display part is closed to approach the main part at a predetermined distance, the electromagnet and the closed loop coil bounce back from each other so that collision of the display part with the main part is prevented.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary side view of a notebook type personal computer in a state that a display part is open according to an embodiment of the invention;

FIG. 2 is an exemplary side view of the notebook type personal computer in a state that the display part is closed in the embodiment; and

FIG. 3 is an exemplary side view of the notebook type personal computer in a state that the display part is closed with an excessive force in the embodiment.

### DETAILED DESCRIPTION

Various embodiments according to the invention will be described hereinafter with reference to the accompanying drawings. In general, according to one embodiment of the invention, an electronic apparatus having a main part and a display part which pivotally opens and closes relative to the main part includes an electromagnet provided in one of the main part and the display part, a permanent magnet provided in the other one of the main part and the display part, and a detection device detecting pivotal movement of the display part, in which when the detection device detects pivotal movement of the display part in an opening direction, the detection device causes the electromagnet to generate a magnetic force to bounce back from the permanent magnet.

Hereinafter, preferred embodiments of an electronic apparatus according to the invention will be explained in detail with reference to the drawings.

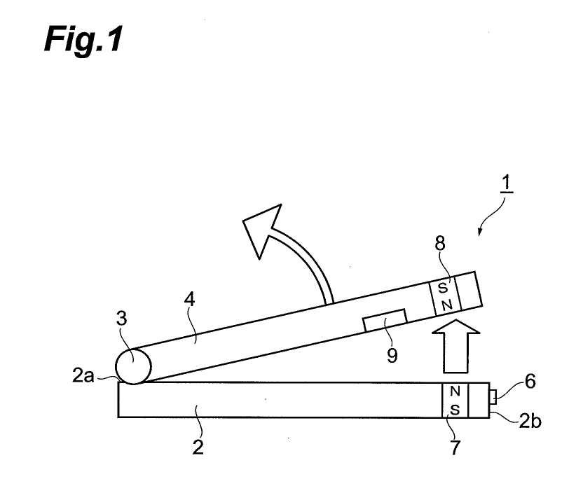

As shown in FIG. 1, a notebook type personal computer (electronic apparatus) 1 according to the invention includes a main part 2 provided with a keyboard for a user to input certain information, and so on.

On a rear end 2a of the main part 2, a display part 4 is provided, which pivotally opens and closes about a hinge 3 relative to the main part 2. This display part 4 is provided with a liquid crystal display screen.

On a front end 2b of the main part 2, a latch 6 is provided. The latch 6 maintains a closed state of the display part 4 when the display part 4 is closed. Note that when the display part 4 is held by the latch 6 and is in a completely closed state, the notebook type personal computer 1 turns to a power saving mode.

On the end 2b side of the main part 2, an electromagnet 7 is provided inside. The electromagnet 7 can change the direction of a generating magnetic force by changing a direction of an electric current.

Inside the display part 4, a permanent magnet 8 is provided at a position to face the electromagnet 7 when the display part 4 is in a closed state. The permanent magnet 8 has an N (north) pole on the main part 2 side and an S (south) pole on the outside thereof.

Also, an acceleration sensor (detection device) 9 is provided inside the display part 4. The acceleration sensor 9 measures acceleration of movement of the display part 4 during an opening/closing operation. By measuring the acceleration of movement, the acceleration sensor 9 can detect pivotal movement of the display part 4. Further, by setting in advance a threshold value for the acceleration of pivotal movement of the display part 4 in a closing direction, it is possible to detect whether or not the display part 4 is pivotally moving at a speed equal to or higher than the threshold value. Note that preferably the threshold value is of acceleration to the extent of not giving a shock on the liquid crystal display screen of the display part 4 when being closed.

The operation and effect of the notebook type personal computer 1 constructed as above will be explained.

As shown in FIG. 1, when the user attempts to open the display part 4 in a closed state, the acceleration sensor 9 detects pivotal movement thereof in an opening direction. According to the detection by the acceleration sensor 9, the electromagnet 7 generates, with the display part 4 side being an N pole, a magnetic force in a direction to bounce back from the permanent magnet 8. Accordingly, the electromagnet 7 and the permanent magnet 8 bounce back from each other to cause the display part 4 to receive a force in the opening direction, and thereby a force needed when opening the display part 4 can be reduced.

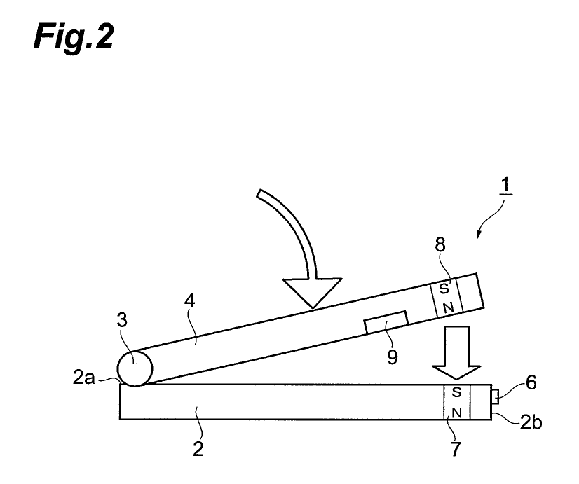

As shown in FIG. 2, when the user attempts to close the display part 4 in an open state, the acceleration sensor 9 detects pivotal movement thereof in the closing direction. According to the detection by the acceleration sensor 9, the electromagnet 7 generates, with the display part 4 side being an S pole, a magnetic force in a direction to be pulled by the permanent magnet 8. Accordingly, the electromagnet 7 and the permanent magnet 8 pull each other to cause the display part 4 to receive a force in the closing direction, and thereby a force needed when closing the display part 4 can be reduced.

As above, since the display part 4 can be opened with a small force, even in a case that the hinge 3 is fixed firmly to a certain extent to prevent rattling, it is possible to prevent the main part 2 from being raised in conjunction with the display part 4 when the display part 4 is opened, thereby realizing smooth opening/closing.

Further, since the operation of the force in the closing direction facilitates closing of the display part 4, turning to the power saving mode can be assured when the display part 4 is closed. Accordingly, further power saving can be realized in the notebook type personal computer 1.

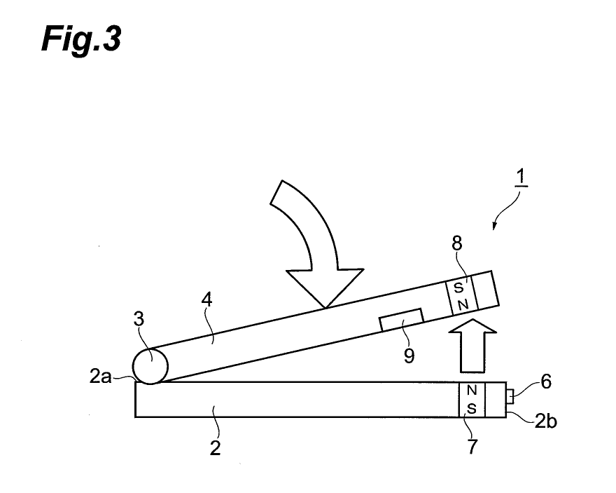

Also, as shown in FIG. 3, when the user attempts to close the display part 4 with an excessive force, the acceleration sensor 9 detects pivotal movement thereof in the closing direction, and also detects movement at a speed equal to or higher than the threshold value. According to the detection by the acceleration sensor 9, the electromagnet 7 generates, with the display part 4 side being an N pole, a magnetic force in a direction to bounce back from the permanent magnet 8. Accordingly, the electromagnet 7 and the permanent magnet 8 bounce back from each other to cause the display part 4 to receive a force in the opening direction, and thereby the excessive closing force can be suppressed so as to prevent giving of a shock on the liquid crystal display screen of the display part 4.

Note that when the display part 4 is in a completely closed state or completely opened state, the current flowing in the electromagnet 7 is cut off.

The invention is not limited to the above-described embodiments. For example, while pivotal movement of the display part is detected by the acceleration sensor in this embodiment, a distance sensor by means of an infrared or the like ray may be used instead. In this case, the sensor may be provided in either of the main part and the display part.

Further, a switch to turn on in the closing direction and turn off in the opening direction may be provided on the hinge or the latch part so as to detect opening/closing of the display part.

Further, while the electromagnet is provided in the main part and the permanent magnet is provided in the display part, the permanent magnet may be provided in the main part and the electromagnet may be provided in the display part instead.

Moreover, while the electronic apparatus according to the invention is a notebook type personal computer, the invention is not limited thereto, and the electronic apparatus may be an electronic organizer, an electronic dictionary or a mobile phone; the electronic apparatus may be, to summarize, any kind of electronic apparatus that has a display part and a main part.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus having a main part and a display part that pivotally opens and closes relative to the main part, the electronic apparatus comprising:
an electromagnet provided in one of the main part or the display part;
a permanent magnet provided in the other one of the main part or the display part; and
a detection device configured to detect pivotal movement of the display part, wherein when said detection device detects pivotal movement of the display part in an opening direction, said detection device causes said electromagnet to generate a magnetic force to repel said permanent magnet.

2. The electronic apparatus according to claim 1, wherein the detection device is configured so that when said detection device detects pivotal movement of the display part in a closing direction, said detection device causes said electromagnet to generate a magnetic force to attract said permanent magnet.

3. The electronic apparatus according to claim 1, wherein the detection device is configured so that when said detection device detects pivotal movement of the display part in a closing direction and also detects acceleration equal to or higher than a predetermined threshold value in the pivotal movement of the display part in the closing direction, said detection device causes said electromagnet to generate a magnetic force to repel said permanent magnet.

4. The electronic apparatus according to claim 1, wherein said detection device comprises an acceleration sensor.
